(19) United States
(12) Patent Application Publication
(10) Pub. No.: US 2024/0353842 A1
(43) Pub. Date: Oct. 24, 2024

(54) POSITION DETERMINATION VIA ENCODED INDICATORS IN A PHYSICAL ENVIRONMENT

(71) Applicant: TORC Robotics, Inc., Blacksburg, VA (US)

(72) Inventors: Joseph FOX-RABINOVITZ, Austin, TX (US); Himanshu SARDESAI, Blacksburg, VA (US)

(73) Assignee: TORC Robotics, Inc., Blacksburg, VA (US)

(21) Appl. No.: 18/302,956

(22) Filed: Apr. 19, 2023

(51) Int. Cl. G05D 1/02; G05D 1/00; G06V 20/56

(52) U.S. Cl. CPC G05D 1/0246; G06V 20/56

(57) ABSTRACT

Aspects of this technical solution can include detecting, by a sensor of a vehicle in a physical environment via visible light, a first object in the physical environment, detecting, by the sensor via the visible light, a first feature a having a digital encoding and located at a surface of the first object, decoding, by a processor of the vehicle and based on the digital encoding, the first feature into a first indication of location corresponding to the first object, generating, by the processor of the vehicle during movement of the vehicle through the physical environment and based on the first indication of location, a location metric corresponding to the vehicle, and modifying, by the processor of the vehicle based on the location metric, operation of the vehicle to navigate the vehicle through the physical environment according to the location metric.

### TECHNICAL FIELD

The present implementations relate generally to managing operations of automated vehicles, including but not limited to position determination via encoded indicators in a physical environment.

### BACKGROUND

Instant resolution of placement in space while moving from place to place or along a path is increasingly expected. However, conventional systems that rely on remote information may be unreliable for timely resolution of placement in space in certain landscapes or environments. Input detected from Global Positioning System (GPS) satellites may not be detectable, or connection with remote systems may not be possible.

### SUMMARY

This technical solution is directed at least to determination of one or more of location and orientation of a vehicle in a physical environment, based on one or more indicators that can be detected by sensors of the vehicle. For example, the vehicle can include one or more cameras that can detect one or more digital codes with visual patterns and can decode, process, identify, or any combination thereof, data included in the visual pattern indicating one or more of location and orientation of the indicator. The vehicle can detect multiple indicators in an environment and can determine a location or orientation of the vehicle relative to the indicators based on data included at or embedded within, for example, the visual indicators. The vehicle can perform a calibration process including detection of one or more indicators at predetermined locations or orientations with respect to the vehicle, to determine parameters for inference of one or more of location and orientation based on one or more sensors of the vehicle. Thus, a technical solution for position determination via encoded indicators in a physical environment is provided.

At least one aspect is directed to a method to spatially position a vehicle in transit through a physical environment. The method can include detecting, by a sensor of a vehicle in a physical environment via any type of electromagnetic radiation, including but not limited to visible light, a first object in the physical environment. The method can include detecting, by the sensor via the visible light, a first feature a having a digital encoding and located at a surface of the first object. The method can include decoding, by a processor of the vehicle and based on the digital encoding, the first feature into a first indication of location corresponding to the first object. The method can include generating, by the processor of the vehicle during movement of the vehicle through the physical environment and based on the first indication of location, a location metric corresponding to the vehicle. The method can include modifying, by the processor of the vehicle based on the location metric, operation of the vehicle to navigate the vehicle through the physical environment according to the location metric.

At least one aspect is directed to a vehicle. The vehicle can include a sensor to detect, via visible light, a first object in a physical environment and a first feature a having a digital encoding and located at a surface of the first object. The vehicle can include a non-transitory memory and a processor to spatially position a vehicle in transit through a physical environment, by decoding, based on the digital encoding, the first feature into a first indication of location corresponding to the first object. The vehicle can include generating, during movement of the vehicle through the physical environment and based on the first indication of location, a location metric corresponding to the vehicle. The vehicle can include modifying, based on the location metric, operation of the vehicle to navigate the vehicle through the physical environment according to the location metric.

At least one aspect is directed to a non-transitory computer readable medium can include one or more instructions stored thereon and executable by a processor. The processor can decode, based on a digital encoding of a first feature located at a surface of a first object in a physical environment, the first feature into a first indication of location corresponding to the first object. The processor can generate, during movement of the vehicle through the physical environment and based on the first indication of location, a location metric corresponding to the vehicle. The processor can modify, based on the location metric, operation of the vehicle to navigate the vehicle through the physical environment according to the location metric.

### BRIEF DESCRIPTION OF THE FIGURES

These and other aspects and features of the present implementations are depicted by way of example in the figures discussed herein. Present implementations can be directed to, but are not limited to, examples depicted in the figures discussed herein.

FIG. 1 depicts an example operating environment, in accordance with present implementations.

FIG. 2 depicts an example calibration environment, in accordance with present implementations.

FIG. 3 depicts an example autonomy system, in accordance with present implementations.

FIG. 4 depicts an example perception module, in accordance with present implementations.

FIG. 5 depicts an example vehicle control module, in accordance with present implementations.

FIG. 6 depicts an example method of detection of encoded indicators in a physical environment, in accordance with present implementations.

FIG. 7 depicts an example method of location determination via encoded indicators in a physical environment, in accordance with present implementations.

### DETAILED DESCRIPTION

Aspects of this technical solution are described herein with reference to the figures, which are illustrative examples of this technical solution. The figures and examples below are not meant to limit the scope of this technical solution to the present implementations or to a single implementation, and other implementations in accordance with present implementations are possible, for example, by way of interchange of some or all of the described or illustrated elements. Where certain elements of the present implementations can be partially or fully implemented using known components, only those portions of such known components that are necessary for an understanding of the present implementations are described, and detailed descriptions of other portions of such known components are omitted to not obscure the present implementations. Terms in the specification and claims are to be ascribed no uncommon or special meaning unless explicitly set forth herein. Further, this technical solution and the present implementations encompass present and future known equivalents to the known components referred to herein by way of description, illustration, or example.

Using state-maintained road signs, other exterior or directional signage, and other fixed landmarks provides limited functionality in determining location of a vehicle, and provide little practical guidance in determining orientation of a vehicle. Challenges with high-precision resolution of location or orientation with state-maintained signage include limited availability of signage, limited availability or absence of metadata regarding signage.

This technical solution is directed at least to a broad distribution of targets along various routes, and placement of metadata directly on the target. Metadata can include, for example, precise geolocation data. Thus, technical improvement including elimination of gaps in available information, case of maintenance, and independence of external authority or control, or communication are achieved by this technical solution. For example, this technical solution is directed at least to include one or more visual codes that can be printed or presented at various physical media, and placed at one or more predetermined routes or predetermined locations. For example, a visual code can include a QR code, a barcode or the like, but is not limited thereto. The visual code can store information to enable more precise navigation. For example, the visual code can include a precise location. A precise location can include one or more of a latitude, a longitude, and an elevation. For example, the visual code can include a date of installation or verification of the visual code. For example, the visual code can include an anti-tampering verification.

A visual code can be placed or installed at any location detectable by a sensor of a vehicle during transit of the vehicle through the physical environment. For example, a visual code can be embedded into, affixed to, or integrated with, one or more of a road sign, a survey marker, a guard rail, a fence, a building, a tree, any improvement to real estate, any natural feature in a physical environment, and a surface installed especially to house the visual indicator.

This technical solution can thus provide a technical improvement of at least high-precision geolocation and orientation in a range of physical environments that cannot be supported by conventional systems. For example, this technical solution can provide the technical improvement of effecting determination of location in physical environment where GPS or Internet are not available. Environments in which GPS or Internet are not available can include, for example, tunnels, urban canyons, and under bridges. This technical solution can be integrated with and be used in conjunction with existing landmarks, including, for example, road signs and roadway markers. The technical solution can also provide a technical improvement of location determination with increased redundancy and increased failure resistance. For example, application of visual indicators with respect to a large number of landmarks can provide “calibration jungles” at known locations along a route. The technical solution including calibration jungles can thus provide at least a technical improvement to enhance sensor precision in addition to providing geolocation information. For example, this technical solution can achieve the technical improvement of increased redundancy and increased failure resistance by leveraging a plurality of landmarks with visual indicators, and outlier rejection in the detection and recognition of indicators.

This technical solution can be integrated with predetermined paths through physical environments, including but not limited to fixed trucking routes. This technical solution can provide high precision information and guidance via road signs, for general purpose autonomous vehicles. This technical solution can achieve at least the technical improvement of a low-cost infrastructure for location and orientation awareness with no requirements for wide-area networks or remote communication. This technical solution can achieve at least the technical improvement of a low-cost infrastructure for location and orientation awareness by integration with road and traffic signs.

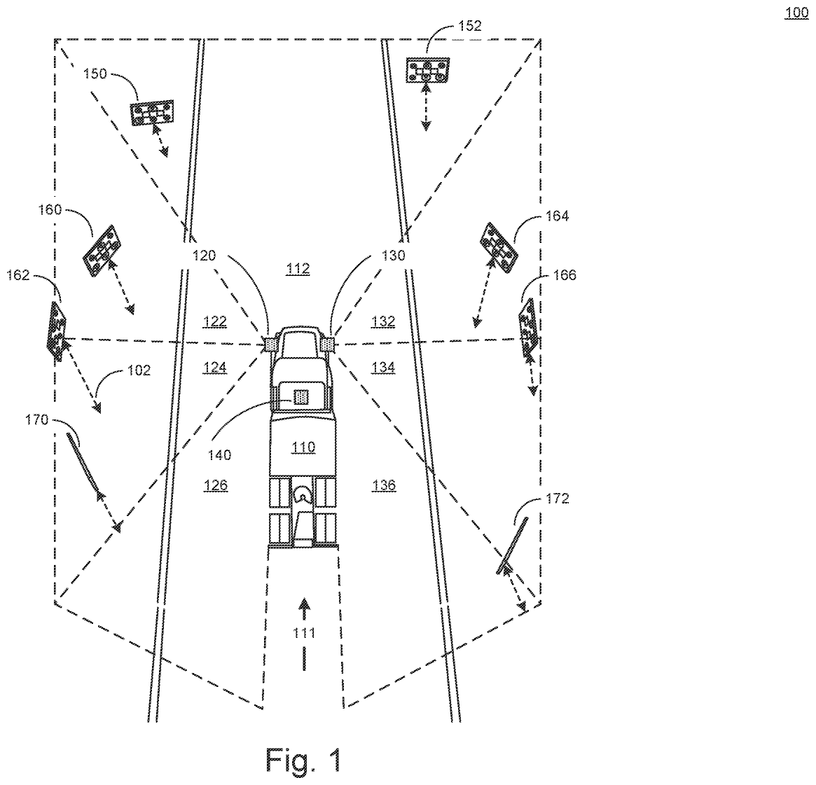

FIG. 1 depicts an example operating environment, in accordance with present implementations. As illustrated by way of example in FIG. 1, an example operating environment 100 can include at least a surface elevation 102, an automated truck 110, lateral targets 160, 162, 164 and 166, and rearward targets 170 and 172.

The surface elevation 102 can correspond to a distance between a lowest portion of a target and a surface of a physical environment. For example, the surface elevation 102 can correspond to an elevation of the target above the surface of the physical environment directly beneath that particular target. For example, the surface elevation 102 can correspond to an elevation of the target above a surface of the physical environment corresponding to sea level. The surface elevation 102 can thus indicate position, for example, in a Z axis or a vertical direction. One or more targets can be associated with distinct corresponding surface elevation 102 properties, to indicate corresponding individualized positions in the vertical direction.

The automated truck 110 can correspond to a motor vehicle that can operate in at least a partially autonomous mode. A partially autonomous mode can include operation of at least a component of the vehicle independently of driver control. The automated trucks can correspond to a motor vehicle powered by a combustion engine, an electric battery, or any combination thereof, for example. The automated truck 110 is described as a truck by way of example, but is not limited to a truck, and can correspond to a motor vehicle having any structure or classification for movement across land, sea, air, or space. The automated truck 110 can include a direction of movement 111, a forward sensor field of view 112, a leftward environment sensor 120, and a rightward environment sensor 130.

The direction of movement 111 can correspond to a heading of the automated truck in the operating environment 100. For example, the operating environment 100 can correspond to an outdoor environment including a roadway, and the automated truck 110 can travel along the roadway in the direction of movement 111. The direction of movement 111 can correspond to a forward motion of the automated truck 110, for example.

The forward sensor field of view 112 can correspond to a portion of a physical environment detectable by one or more sensors of the leftward environment sensor 120 and the rightward environment sensor 130. For example, one or more of the leftward environment sensor 120 and the rightward environment sensor 130 can be at least partially oriented in the operating environment to detect the physical environment in the forward sensor field of view 112. For example, as discussed herein, a physical environment can correspond to one or more environments at least partially surrounding the automated truck 110, including but not limited to the operating environment 100.

The leftward environment sensor 120 can include one or more devices to detect properties of the operating environment 100 or any physical environment within a field of view thereof. For example, the leftward environment sensor 120 can include one or more cameras configured to capture one or more images as still images, video, or any combination thereof. The leftward environment sensor 120 can capture one or more images in one or more spectra of light by one or more cameras configured to capture those spectra and oriented to one or more corresponding fields of view. For example, the leftward environment sensor 120 can include a first camera configured to capture images or video in a spectrum of light corresponding to visible light, and a second camera configured to capture images or video in a spectrum of light corresponding to infrared light or ultraviolet light. The leftward environment sensor 120 can include one or more cameras configured to capture any spectrum of electromagnetic radiation and is not limited to the spectra or combination of spectra discussed herein by way of example.

The leftward environment sensor 120 can be oriented toward one or more of a forward-left sensor field of view 122, a middle-left sensor field of view 124, and a rear-left sensor field of view 126. The forward-left sensor field of view 122 can correspond to a portion of a physical environment detectable by one or more sensors of the leftward environment sensor 120 positioned adjacent to and left of the forward sensor field of view 112 with respect to a front of the automated truck 110. For example, the leftward environment sensor 120 can be at least partially oriented in the operating environment 100 to detect the physical environment in the forward-left sensor field of view 112. The middle-left sensor field of view 124 can correspond to a portion of a physical environment detectable by one or more sensors of the leftward environment sensor 120 positioned adjacent to and behind the forward-left sensor field of view 122 with respect to a front of the automated truck 110. For example, the leftward environment sensor 120 can be at least partially oriented in the operating environment 100 to detect the physical environment in the middle-left sensor field of view 124. The rear-left sensor field of view 126 can correspond to a portion of a physical environment detectable by one or more sensors of the leftward environment sensor 120 positioned adjacent to and behind the middle-left sensor field of view 124 with respect to a front of the automated truck 110. For example, the leftward environment sensor 120 can be at least partially oriented in the operating environment 100 to detect the physical environment in the rear-left sensor field of view 126.

The rightward environment sensor 130 can correspond at least partially in one or more of structure and operation to the leftward environment sensor 120. The rightward environment sensor 130 can be oriented toward one or more of a forward-right sensor field of view 132, a middle-right sensor field of view 134, and a rear-right sensor field of view 136. The forward-right sensor field of view 132 can correspond to a portion of a physical environment detectable by one or more sensors of the rightward environment sensor 130 positioned adjacent to and right of the forward sensor field of view 112 with respect to a front of the automated truck 110. For example, the rightward environment sensor 130 can be at least partially oriented in the operating environment 100 to detect the physical environment in the forward-right sensor field of view 132. The middle-right sensor field of view 134 can correspond to a portion of a physical environment detectable by one or more sensors of the rightward environment sensor 130 positioned adjacent to and behind of the forward-right sensor field of view 132 with respect to a front of the automated truck 110. For example, the rightward environment sensor 130 can be at least partially oriented in the operating environment 100 to detect the physical environment in the middle-right sensor field of view 134. The rear-right sensor field of view 136 can correspond to a portion of a physical environment detectable by one or more sensors of the rightward environment sensor 130 positioned adjacent to and behind of the middle-right sensor field of view 134 with respect to a front of the automated truck 110. For example, the rightward environment sensor 130 can be at least partially oriented in the operating environment 100 to detect the physical environment in the rear-right sensor field of view 136.

The lateral targets 160, 162, 164 and 166 and the rearward targets 170 and 172 can be positioned in the operating environment 100 at positions relative to the automated truck 110 within a detectable distance and line of sight of one or more of the leftward environment sensor 120 and the rightward environment sensor 130. For example, the lateral targets 160, 162, 164 and 166 and the rearward targets 170 and 172 can be integrated with, placed upon, or affixed to signage corresponding to a roadway and within line of sight of an operator of a motor vehicle positioned at or within the roadway. For example, the lateral targets 160, 162, 164 and 166 can include or correspond to a visual code that can be embedded into, affixed to, or integrated with, one or more of a road sign, a survey marker, a guard rail, a fence, a building, a tree, any improvement to real estate, any natural feature in a physical environment, and a surface installed especially to house the visual indicator. The lateral targets 160, 162, 164 and 166 can be positioned at one or more of left and right sides of the automated truck 110. The rearward targets 170 and 172 can be positioned at one or more of left and right sides behind the automated truck 110. For example, the lateral targets 160, 162, 164 and 166 and the rearward targets 170 and 172 can be positioned off the roadway or a designated area where the automated truck 110 may be located in the direction of travel 111. This technical solution is not limited to the number and position of targets as illustrated herein by way of example.

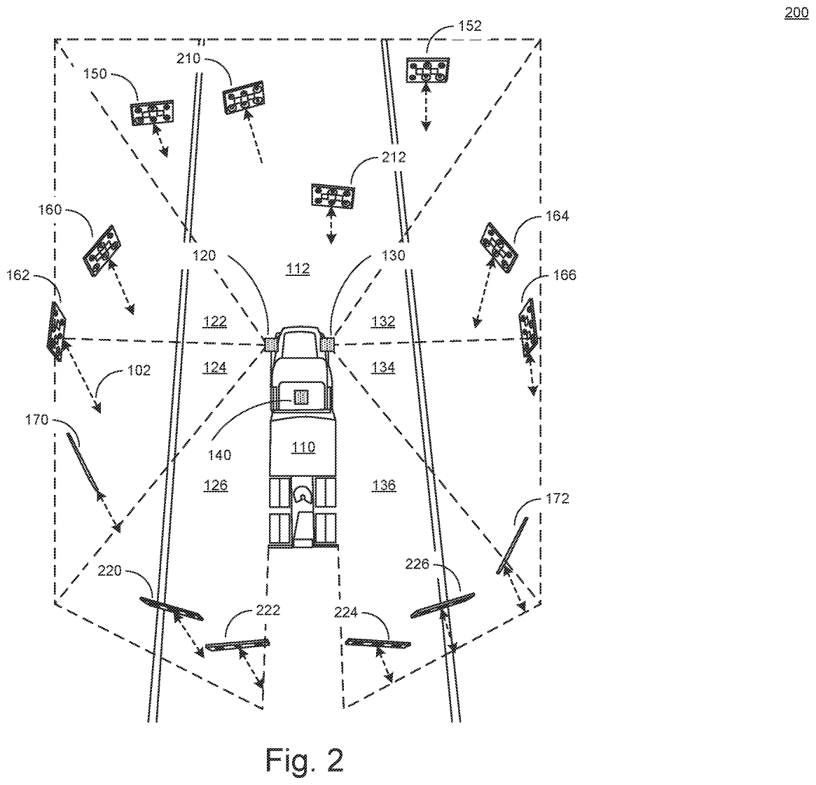

FIG. 2 depicts an example calibration environment, in accordance with present implementations. As illustrated by way of example in FIG. 2, an example calibration environment 200 can include at least the lateral targets 160, 162, 164 and 166, the rearward targets 170 and 172, forward calibration targets 210 and 212, and rearward calibration targets 220, 222, 224 and 226.

The calibration environment 200 can correspond to a physical environment including a plurality of targets having a density or number greater than a number of targets in the operating environment 100. For example, the calibration environment 200 can correspond to a warehouse, depot, truck stop, or the like, including one or more targets that can be moveably or temporarily placed in a path of movement of the vehicle. Thus, the calibration environment 200 can correspond to a “calibration jungle” to provide a higher density of targets for determination of location and orientation of the automated truck 110 that may exist in an operating environment 100.

The forward calibration targets 210 and 212 and the rearward calibration targets 220, 222, 224 and 226 can be positioned in the calibration environment 200 at positions relative to the automated truck 110 within a detectable distance and line of sight of one or more of the leftward environment sensor 120 and the rightward environment sensor 130. For example, the forward calibration targets 210 and 212 and the rearward calibration targets 220, 222, 224 and 226 can be integrated with, placed upon, or affixed to signage corresponding to a roadway and within line of sight of an operator of a motor vehicle positioned at or within the roadway. The forward calibration targets 210 and 212 and the rearward calibration targets 220, 222, 224 and 226 can correspond at least partially in one or more of structure and operation to the lateral targets 160, 162, 164 and 166 and the rearward targets 170 and 172, and can be positioned at any point around the automated truck 110. For example, the lateral targets 160, 162, 164 and 166 and the rearward targets 170 and 172 can be positioned on a roadway or a designated area where the automated truck 110 may be located in the direction of travel 111.

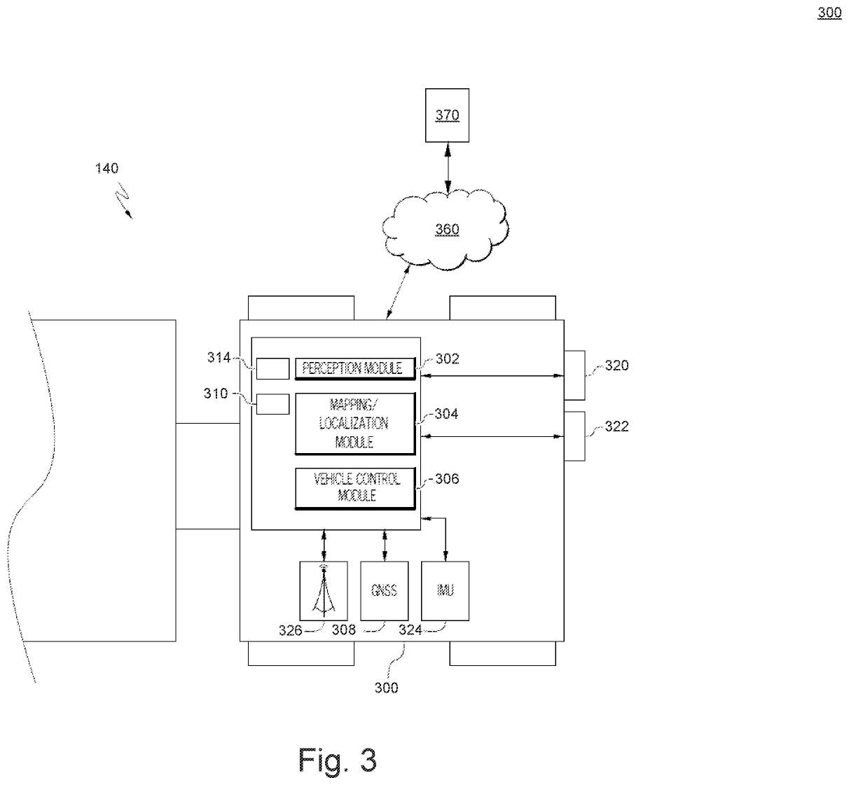

FIG. 3 shows example components of an autonomy system 300 on board an automated vehicle, such as an automated truck 110 (e.g., automated truck 110), according to an embodiment. The autonomy system 300 may include a perception system comprises hardware and software components for the vehicle system 110 to perceive an environment (e.g., environment 100). The components of the perception system include, for example, a camera system 320, a LiDAR system 322, a GNSS receiver 308, an inertial measurement unit (IMU) 324, and/or a perception module 302. The autonomy system 300 may further include a transceiver 326, a processor 310, a memory 314, a mapping/localization module 304, and a vehicle control module 306. The various systems may serve as inputs to and receive outputs from various other components of the autonomy system 300. In other examples, the autonomy system 300 may include additional, fewer, or different components or systems. Similarly, each of the components or system(s) may include additional, fewer, or different components. Additionally, the systems and components shown may be combined or divided in various ways. The perception systems of the autonomy system 300 may help the truck 110 perceive the environment and perform various actions.

The camera system 320 of the perception system may include one or more cameras mounted at any location on the truck 110, which may be configured to capture images of the environment surrounding the truck 110 in any aspect or field of view (FOV) (e.g., perception field 130). The FOV can have any angle or aspect such that images of the areas ahead of, to the side, and behind the truck 110 may be captured. In some embodiments, the FOV may be limited to particular areas around the truck 110 (e.g., forward of the truck 110) or may surround 360 degrees of the truck 110. In some embodiments, the image data generated by the camera system(s) 320 may be sent to the perception module 302 and stored, for example, in memory 314. In some embodiments, the image data generated by the camera system(s) 320, as well as any classification data or object detection data (e.g., bounding boxes, estimated distance information, velocity information, mass information) generated by the object tracking and classification module 230, can be transmitted to the remote server 370 for additional processing (e.g., correction of detected misclassifications from the image data, training of artificial intelligence models).

The LiDAR system 322 may include a laser generator and a detector and can send and receive a LIDAR signals. The LiDAR signal can be emitted to and received from any direction such that LiDAR point clouds (or “LiDAR images”) of the areas ahead of, to the side, and behind the truck 110 can be captured and stored as LiDAR point clouds. In some embodiments, the truck 110 may include multiple LiDAR systems and point cloud data from the multiple systems may be stitched together. In some embodiments, the system inputs from the camera system 320 and the LiDAR system 322 may be fused (e.g., in the perception module 302). The LiDAR system 322 may include one or more actuators to modify a position and/or orientation of the LiDAR system 322 or components thereof. The LIDAR system 322 may be configured to use ultraviolet (UV), visible, or infrared light to image objects and can be used with a wide range of targets. In some embodiments, the LiDAR system 322 can be used to map physical features of an object with high resolution (e.g., using a narrow laser beam). In some examples, the LiDAR system 322 may generate a point cloud and the point cloud may be rendered to visualize the environment surrounding the truck 110 (or object(s) therein). In some embodiments, the point cloud may be rendered as one or more polygon(s) or mesh model(s) through, for example, surface reconstruction. Collectively, the LiDAR system 322 and the camera system 320 may be referred to herein as “imaging systems.”

The GNSS receiver 308 may be positioned on the truck 110 and may be configured to determine a location of the truck 110 via GNSS data, as described herein. The GNSS receiver 308 may be configured to receive one or more signals from a global navigation satellite system (GNSS) (e.g., GPS system) to localize the truck 110 via geolocation. The GNSS receiver 308 may provide an input to and otherwise communicate with mapping/localization module 304 to, for example, provide location data for use with one or more digital maps, such as an HD map (e.g., in a vector layer, in a raster layer or other semantic map). In some embodiments, the GNSS receiver 308 may be configured to receive updates from an external network.

The IMU 324 may be an electronic device that measures and reports one or more features regarding the motion of the truck 110. For example, the IMU 324 may measure a velocity, acceleration, angular rate, and or an orientation of the truck 110 or one or more of its individual components using a combination of accelerometers, gyroscopes, and/or magnetometers. The IMU 324 may detect linear acceleration using one or more accelerometers and rotational rate using one or more gyroscopes. In some embodiments, the IMU 324 may be communicatively coupled to the GNSS receiver 308 and/or the localization module 304, to help determine a real-time location of the truck 110, and predict a location of the truck 110 even when the GNSS receiver 308 cannot receive satellite signals.

The transceiver 326 may be configured to communicate with one or more external networks 360 via, for example, a wired or wireless connection in order to send and receive information (e.g., to a remote server 370). The wireless connection may be a wireless communication signal (e.g., Wi-Fi, cellular, LTE, 5g). In some embodiments, the transceiver 326 may be configured to communicate with external network(s) via a wired connection, such as, for example, during initial installation, testing, or service of the autonomy system 300 of the truck 110. A wired/wireless connection may be used to download and install various lines of code in the form of digital files (e.g., HD digital maps), executable programs (e.g., navigation programs), and other computer-readable code that may be used by the system 300 to navigate the truck 110 or otherwise operate the truck 110, either fully-autonomously or semi-autonomously. The digital files, executable programs, and other computer readable code may be stored locally or remotely and may be routinely updated (e.g., automatically or manually) via the transceiver 326 or updated on demand.

In some embodiments, the truck 110 may not be in constant communication with the network 360 and updates which would otherwise be sent from the network 360 to the truck 110 may be stored at the network 360 until such time as the network connection is restored. In some embodiments, the truck 110 may deploy with all of the data and software it needs to complete a mission (e.g., necessary perception, localization, and mission planning data) and may not utilize any connection to network 360 during some or the entire mission. Additionally, the truck 110 may send updates to the network 360 (e.g., regarding unknown or newly detected features in the environment as detected by perception systems) using the transceiver 326. For example, when the truck 110 detects differences in the perceived environment with the features on a digital map, the truck 110 may update the network 360 with information, as described in greater detail herein.

The processor 310 of autonomy system 300 may be embodied as one or more of a data processor, a microcontroller, a microprocessor, a digital signal processor, a logic circuit, a programmable logic array, or one or more other devices for controlling the autonomy system 300 in response to one or more of the system inputs. Autonomy system 300 may include a single microprocessor or multiple microprocessors that may include means for identifying and reacting to differences between features in the perceived environment and features of the maps stored on the truck. Numerous commercially available microprocessors can be configured to perform the functions of the autonomy system 300. It should be appreciated that autonomy system 300 could include a general machine controller capable of controlling numerous other machine functions. Alternatively, a special-purpose machine controller could be provided. Further, the autonomy system 300, or portions thereof, may be located remote from the system 300. For example, one or more features of the mapping/localization module 304 could be located remote of truck. Various other known circuits may be associated with the autonomy system 300, including signal-conditioning circuitry, communication circuitry, actuation circuitry, and other appropriate circuitry.

The memory 314 of autonomy system 300 includes any non-transitory machine-readable storage medium that stores data and/or software routines that assist the autonomy system 300 in performing various functions, such as the functions of the perception module 302, the mapping/localization module 304, the vehicle control module 306, or an object tracking and classification module 230, among other functions of the autonomy system 300. Further, the memory 314 may also store data received from various inputs associated with the autonomy system 300, such as perception data from the perception system. For example, the memory 314 may store image data generated by the camera system(s) 320, as well as any classification data or object detection data (e.g., bounding boxes, estimated distance information, velocity information, mass information) generated by the object tracking and classification module 230.

As noted above, perception module 302 may receive input from the various sensors, such as camera system 320, LiDAR system 322, GNSS receiver 308, and/or IMU 324 (collectively “perception data”) to sense an environment surrounding the truck and interpret it. To interpret the surrounding environment, the perception module 302 (or “perception engine”) may identify and classify objects or groups of objects in the environment. For example, the truck 110 may use the perception module 302 to identify one or more objects (e.g., pedestrians, vehicles, debris, etc.) or features of the roadway (e.g., intersections, road signs, lane lines) before or beside a vehicle and classify the objects in the road. In some embodiments, the perception module 302 may include an image classification function and/or a computer vision function. In some implementations, the perception module 302 may include, communicate with, or otherwise utilize the object tracking and classification module 230 to perform object detection and classification operations.

The system 300 may collect perception data. The perception data may represent the perceived environment surrounding the truck 110, for example, and may be collected using aspects of the perception system described herein. The perception data can come from, for example, one or more of the LiDAR system, the camera system, and various other externally-facing sensors and systems on board the truck 110 (e.g., GNSS 308 receiver). For example, on vehicles having a sonar or radar system, the sonar and/or radar systems may collect perception data. As the truck 110 travels along the roadway, the system 300 may continually receive data from the various systems on the truck 110. In some embodiments, the system 300 may receive data periodically and/or continuously.

The system 300 may compare the collected perception data with stored data. For instance, the system 300 may identify and classify various features detected in the collected perception data from the environment with the features stored in a digital map. For example, the detection systems of the system 300 may detect the lane lines and may compare the detected lane lines with lane lines stored in a digital map. Additionally, the detection systems of the system 300 could detect the traffic lights by comparing such features with features in a digital map. The features may be stored as points (e.g., signs, small landmarks), lines (e.g., lane lines, road edges), or polygons (e.g., lakes, large landmarks) and may have various properties (e.g., style, visible range, refresh rate, etc.), where such properties may control how the system 300 interacts with the various features. In some embodiments, based on the comparison of the detected features against the features stored in the digital map(s), the system 300 may generate a confidence level, which may represent a confidence in the calculated location of the truck 110 with respect to the features on a digital map and hence, the actual location truck 110 as determined by the system 300.

The image classification function may determine the features of an image (e.g., visual image from the camera system 320 and/or a point cloud from the LiDAR system 322). The image classification function can be any combination of software agents and/or hardware modules able to identify image features and determine attributes of image parameters in order to classify portions, features, or attributes of an image. The image classification function may be embodied by a software module (e.g., the object detection and classification module 230) that may be communicatively coupled to a repository of images or image data (e.g., visual data and/or point cloud data) which may be used to detect and classify objects and/or features in real time image data captured by, for example, the camera system 320 and the LiDAR system 322. In some embodiments, the image classification function may be configured to detect and classify features based on information received from only a portion of the multiple available sources. For example, in the case that the captured visual camera data includes images that may be blurred, the system 300 may identify objects based on data from one or more of the other systems (e.g., LiDAR system 322) that does not include the image data.

The computer vision function may be configured to process and analyze images captured by the camera system 320 and/or the LiDAR system 322 or stored on one or more modules of the autonomy system 300 (e.g., in the memory 314), to identify objects and/or features in the environment surrounding the truck 110 (e.g., lane lines). The computer vision function may use, for example, an object recognition algorithm, video tracing, one or more photogrammetric range imaging techniques (e.g., a structure from motion (SfM) algorithms), or other computer vision techniques. The computer vision function may be configured to, for example, perform environmental mapping and/or track object vectors (e.g., speed and direction). In some embodiments, objects or features may be classified into various object classes using the image classification function, for instance, and the computer vision function may track the one or more classified objects to determine aspects of the classified object (e.g., aspects of its motion, size). The computer vision function may be embodied by a software module (e.g., the object detection and classification module 230) that may be communicatively coupled to a repository of images or image data (e.g., visual data; point cloud data), and may additionally implement the functionality of the image classification function.

Mapping/localization module 304 receives perception data that can be compared to one or more digital maps stored in the mapping/localization module 304 to determine where the truck 110 is in the world and/or or where the truck 110 is on the digital map(s). In particular, the mapping/localization module 304 may receive perception data from the perception module 302 and/or from the various sensors sensing the environment surrounding the truck 110, and may correlate features of the sensed environment with details (e.g., digital representations of the features of the sensed environment) on the one or more digital maps. The digital map may have various levels of detail and can be, for example, a raster map, a vector map, or the like. The digital maps may be stored locally on the truck 110 and/or stored and accessed remotely. In at least one embodiment, the truck 110 deploys with sufficiently stored information in one or more digital map files to complete a mission without connection to an external network during the mission. A centralized mapping system may be accessible via network 360 for updating the digital map(s) of the mapping/localization module 304. The digital map may be built through repeated observations of the operating environment using the truck 110 and/or trucks or other vehicles with similar functionality. For instance, the truck 110, a specialized mapping vehicle, a standard automated vehicle, or another vehicle, can run a route several times and collect the location of all targeted map features relative to the position of the truck 110 conducting the map generation and correlation. These repeated observations can be averaged together in a known way to produce a highly accurate, high-fidelity digital map. This generated digital map can be provided to each truck 110 (e.g., from a remote server 370 via a network 360 to the truck 110) before the truck 110 departs on a mission so the truck 110 can carry the digital onboard and use the digital map data within the mapping/localization module 304. Hence, the truck 110 and other vehicles (e.g., a fleet of trucks similar to the truck 110) can generate, maintain (e.g., update), and use a particular instance of each truck's 110 generated maps when conducting a mission.

The generated digital map may include an assigned confidence score assigned to all or some of the individual digital feature representing a feature in the real world. The confidence score may be meant to express the level of confidence that the position of the element reflects the real-time position of that element in the current physical environment. Upon map creation, after appropriate verification of the map (e.g., running a similar route multiple times such that a given feature is detected, classified, and localized multiple times), the confidence score of each element will be very high, possibly the highest possible score within permissible bounds.

The vehicle control module 306 may control the behavior and maneuvers of the truck. For example, once the systems on the truck have determined its location with respect to map features (e.g., intersections, road signs, lane lines) the truck may use the truck 110 control module 306 and its associated systems to plan and execute maneuvers and/or routes with respect to the features of the environment. The vehicle control module 306 may make decisions about how the truck 110 will move through the environment to get to a goal or destination as the truck 110 completes the mission. The vehicle control module 306 may consume information from the perception module 302 and the maps/localization module 304 to know where the truck 110 is relative to the surrounding environment and what other traffic actors are doing.

The vehicle control module 306 may be communicatively and operatively coupled to a plurality of vehicle operating systems and may execute one or more control signals and/or schemes to control operation of the one or more operating systems, for example, the vehicle control module 306 may control one or more of a vehicle steering system, a propulsion system, and/or a braking system. The propulsion system may be configured to provide powered motion for the truck and may include, for example, an engine/motor, an energy source, a transmission, and wheels/tires and may be coupled to and receive a signal from a throttle system, for example, which may be any combination of mechanisms configured to control the operating speed and acceleration of the engine/motor and thus, the speed/acceleration of the truck. The steering system may be any combination of mechanisms configured to adjust the heading or direction of the truck. The brake system may be, for example, any combination of mechanisms configured to decelerate the truck (e.g., friction braking system, regenerative braking system). The vehicle control module 306 may be configured to avoid obstacles in the environment surrounding the truck and may be configured to use one or more system inputs to identify, evaluate, and modify a vehicle trajectory. The vehicle control module 306 is depicted as a single module, but can be any combination of software agents and/or hardware modules able to generate vehicle control signals operative to monitor systems and control various vehicle actuators. The vehicle control module 306 may include a steering controller for vehicle lateral motion control and a propulsion and braking controller for vehicle longitudinal motion.

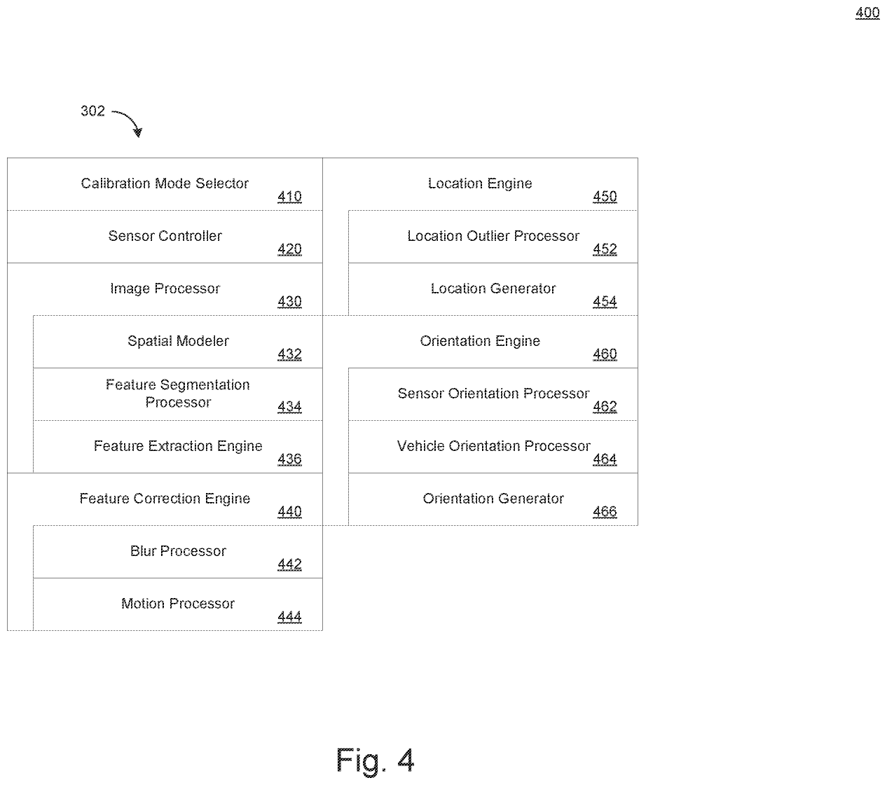

FIG. 4 depicts an example perception module, in accordance with present implementations. As illustrated by way of example in FIG. 4, an example perception module 400 can include at least a calibration mode selector 410, a sensor controller 420, an image processor 430, a feature correction engine 440, a location engine 450, and an orientation engine 460. The perception module 400 can correspond at least partially in one or more of structure and operation to the perception module 302.

The calibration mode selector 410 can select between operation of the perception module 400 in a calibration mode and an operating mode. For example, in a calibration mode, the perception module can detect one or more targets in accordance with the calibration environment 200, and can determine one or more of a location and an orientation of the automated truck 110 based on corresponding data of one or more visual codes of the targets in the calibration environment 200.

The sensor controller 420 can operate one or more sensors of the leftward environment sensor 120, the rightward environment sensor 130, and the camera system 320. The camera system 320 can correspond at least partially in one or more of structure and operation to one or more of the leftward environment sensor 120, the rightward environment sensor 130 as discussed herein. For example, the sensor controller 420 can select and obtain still or video images from one or more of the leftward environment sensor 120, the rightward environment sensor 130, and the camera system 320 in one or more selected spectra.

The image processor 430 can generate one or more image or video objects corresponding to sensor data obtained by the sensor controller 420. For example, the image processor 430 can generate one or more images files or video files including one or more images files in a sequential order based on time, and including images files derived from input from one or more cameras or sensors of the automated truck 110. The image processor 430 can include a spatial modeler 432, a feature segmentation processor 434, and a feature extraction engine 436.

The spatial modeler 432 can generate a representation of a physical environments including one or more targets, and can correlate one or more detected targets with one or more particular positions within the physical environment. For example, the spatial modeler 432 can identify one or more portions a physical environment that can correspond to a target based on one or more feature of the target. For example, the spatial modeler 432 can generate a three-dimensional model corresponding to the relative positions of one or more targets with respect to the automated truck 110 in accordance with one or more of the operating environment 100 and the calibration environment 200. The spatial modeler 432 can transmit to the feature segmentation processor 434, one or more of the particular positions within the physical environment corresponding to potential targets, and can transmit relative position of the target with respect to the automated vehicle, based on the positions of the potential target in the field of view of the sensor of the automated truck 110.

The feature segmentation processor 434 can identify portions of image data or video data that include visual codes compatible with one or more of the location engine 450 and the orientation engine 460. The feature segmentation processor 434 can obtain a target model from the spatial modeler 432, or one or more portions thereof that indicate potential presence of a visual code compatible with one or more of the location engine 450 and the orientation engine 460. For example, the feature segmentation processor 434 can attempt to identify targets restricted to a portion of a physical environment external to the roadway or the direction of movement 111, in an operating mode as selected by the calibration mode selector 410. For example, the feature segmentation processor 434 can attempt to identify targets of a physical environment at or in a roadway and he direction of movement 111, and external to the roadway or the direction of movement 111, in calibration mode as selected by the calibration mode selector 410.

The feature segmentation processor 434 can include one or more machine vision processors configured to recognize features in an environment at greater than 1 Hz. For example, the feature segmentation processor 434 can include a feature recognition engine to sample an image at over 60 Hz, to identify, bitmaps, vectors, or any combination thereof, in the image data or frames of the video data at a rate corresponding to movement of the automated truck at speeds up to or exceeding highway speeds. For example, highway speeds can be between 45 miles per hour (MPH) and 100 MPH. Thus, the feature segmentation processor 434 can provide at least the technical improvement of identifying portions of an environment having visual codes during movement through the physical environment at high speeds exceeding capacity of identification of those visual codes by manual inspection.

The feature extraction engine 436 can generate or reconstruct one or more visual codes based on portions of the physical environment identified by the feature segmentation processor 434. For example, the feature segmentation processor 434 can identify portion of image data having a collection of black-and-white or light-and-dark visual portions potentially corresponding to a QR code, based on a code assessment metric of the portion of image data that satisfies a code assessment threshold. For example, the code assessment metric can correspond to a histogram of the portion of image data. For example, the code assessment threshold can correspond to a maximum deviation from a histogram of a QR code compatible with one or more of the location engine 450 and the orientation engine 460. For example, the code assessment threshold can correspond to a maximum deviation from a histogram of an arithmetic mean of a plurality of histograms corresponding to a plurality of QR codes compatible with one or more of the location engine 450 and the orientation engine 460. The feature extraction engine 436 can transmit the visual codes to the feature correction engine 440.

The feature correction engine 440 can modify one or more visual codes received from the feature extraction engine 436. For example, the feature correction engine 440 can modify one or more visual parameters of a visual code to increase compatibility of the visual code with one or more of the location engine 450 and the sensor orientation engine 460. The feature correction engine 440 can include a blur processor 442 and a motion processor 444. The blur processor 442 can reduce or eliminate distortion of a visual code due to blur within a particular image. For example, the blur processor 442 can modify a visual code corresponding to a QR code by reducing the number of colors or brightness levels in the visual code to correspond more closely to the black-and-white color palette of a QR code. The color reduction is not limited to black-and-white, and can include, for example, histogram-based modification of an image to amplify any particular color or colors, and to decrease or eliminate any color or colors. no part of a particular type of visual code. The motion processor 444 can reduce or eliminate distortion of a visual code due to blur within a particular image or across multiple images each constituting portions of a video. For example, the motion processor 444 can modify a visual code corresponding to a QR code by identifying a magnitude of velocity of the automated truck 110 and modifying one or more dimensions of the QR code based on the magnitude of velocity of the automated truck 110

The location engine 450 can determine a location of a vehicle based on one or more visual codes detected from the image processor 430 and optionally corrected by the features correction engine 440. For example, the location engine 450 can extract location indicators from one or more of the obtained visual codes, and can determine a location of the vehicle based on processing location indicators from one or more of the visual codes. For example, the location engine 450 can read a QR code to extract a location identifier including one or more of latitude, longitude, and altitude or elevation. The location engine 450 and components thereof can provide at least the technical improvement of determining location of the automated truck 110 at high speeds exceeding capacity of identification of location based on those visual codes by manual inspection, with reduced or eliminated reliance on external communication networks or electronic systems. The location engine 450 can include a location outlier processor 452 and a location generator 454.

The location outlier processor 452 can select or deselect one or more location indicators, in response to a determination that one or more of the location indicators satisfy an outlier threshold. For example, the location outlier processor 452 can determine a deviation between one or more location indicators based on a threshold deviation in standard deviations from a mean or median location indicated by the location indicators in aggregate. Thus, the location outlier processor 452 can provide a technical solution of determination of location with high accuracy and with low to no drift in determination of location, based on presence of erroneous visual codes in a physical environment. The location generator 454 can generate a location including one or more of latitude, longitude, and altitude or elevation, of the automated truck 110 in the physical environment. The location generator 454 can transmit one or more of the generated location or any component thereof, including one or more of the latitude, longitude, and altitude or elevation, to the vehicle control module 306.

The orientation engine 460 can determine an orientation of a vehicle based on one or more visual codes detected from the image processor 430 and optionally corrected by the feature correction engine 440. For example, the orientation engine 460 can obtain an identification of one or more frames of a camera from which the location generator 454 has generated location indicators. For example, the orientation engine 460 can generate an orientation of the automated truck in one or more axes or one or more angles with respect to one or more axes, based on the orientation indicators and the relative position of respective ones of the orientation indicators in the field of view of particular sensors of the automated truck 110. The orientation engine 460 and components thereof can provide at least the technical improvement of determining orientation of the automated truck 110 at high speeds exceeding capacity of identification of orientation based on visual codes by manual inspection, with reduced or eliminated reliance on external communication networks or electronic systems. The orientation engine 460 can include a sensor orientation processor 462, a vehicle orientation processor 464, and an orientation generator 466. The sensor orientation processor 462 can determine an orientation of a sensor in a physical environment based on one or more of an orientation indicator and a sensor corresponding to a field of view. For example, the sensor orientation processor 462 can determine a position of a visual code in a field of view of the sensor, and can determine one or more of a horizontal position and a vertical position of the visual code in the field of view. Thus, the sensor orientation processor 462 can link a particular horizontal and vertical position in a field of view with a particular sensor, to provide a visual position of the visual code with respect to the sensor.

The vehicle orientation processor 464 can determine an orientation of the vehicle based on a comparison of one or more location identifiers of one or more corresponding visual codes, and one or more visual positions of the respective visual code in particular fields of view. For example, the vehicle orientation processor 464 can offset a visual position of the sensor with a visual position detected based on the visual code by the sensor orientation processor 462, to determine a displacement along one or more axes or one or more angles with respect to the automated truck 110. The vehicle orientation processor 464 can generate a plane based on location indicators, by, for example, creating a plane based on the latitude, longitude, and elevation components of the location indicators within a target model corresponding to the physical environment. The vehicle orientation processor 464 can thus determine orientation of the automated vehicle relative to the plane detected, based on the positions of the visual codes within the field of view respective to their expected positions in the target model. The vehicle orientation processor 464 can generate a second plane corresponding to the orientation of the vehicle based on the visual positions, and can identify a difference between orientation based on a difference between the two plane, for example. The orientation generator 466 can generate a location including one or more of heading, pitch, and roll, of the automated truck 110 in the physical environment. The orientation generator 466 can transmit one or more of the generated orientation or any component thereof, including one or more of the heading, pitch, and roll, to the vehicle control module 306.

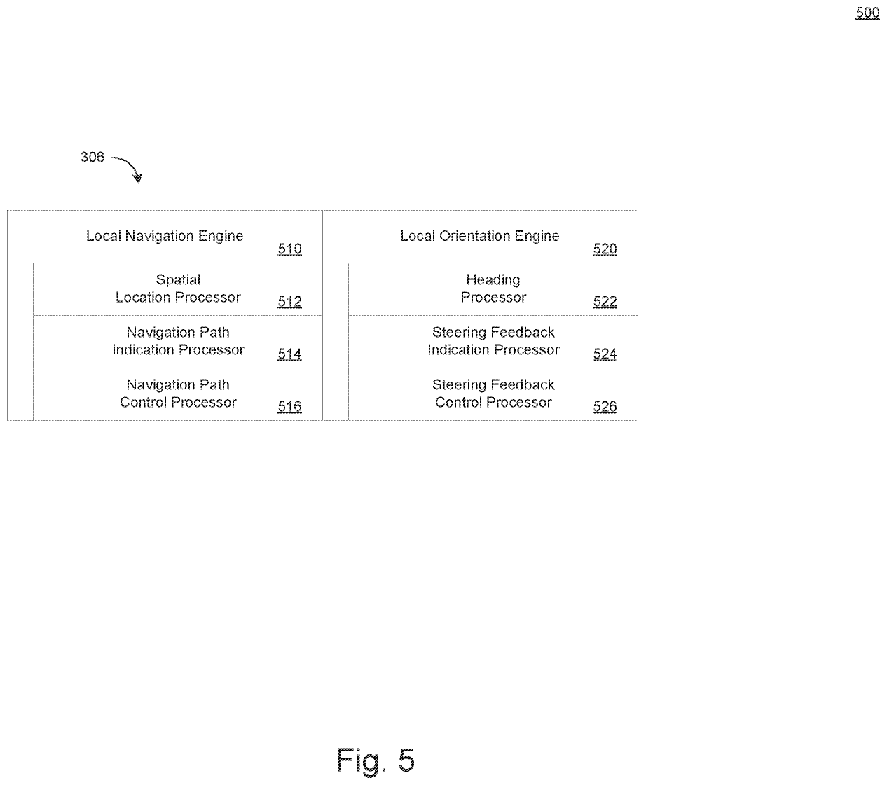

FIG. 5 depicts an example vehicle control module, in accordance with present implementations. As illustrated by way of example in FIG. 5, an example vehicle control module 500 can include at least a local navigation engine 510 and a local orientation engine 520.

The local navigation engine 510 can control movement of the automated truck 110 through or between particular locations. For example, the local navigation engine 510 can control the automated truck 110 to navigate from a first location corresponding to a first latitude and longitude pair to a second location corresponding to a second latitude and longitude pair. The local navigation engine 510 can modify a route of the automated truck 110 based on a location indicator or latitude and longitude derived from a location indicator. Thus, the local navigation engine 510 can provide a technical solution of providing real-time or live navigation calibration, correction, and control to an automated truck 110, to provide a technical improvement including navigation calibration, correction, and control independent of external communication networks. The local navigation engine 510 can include a spatial location processor 512, a navigation path indication processor 514, and a navigation path control processor 516. The spatial location processor 512 can modify a location of the local navigation engine 510 based on a location generated by the location engine 450. For example, the spatial location processor 512 can store or modify a location of the automated truck 110 in the target model or in a navigation model corresponding to the location generated by the location engine 450.

The navigation path indication processor 514 can modify a navigation path to, or from a location based on the location indicator or latitude and longitude derived from a location indicator. For example, the navigation path indication processor 514 can instruct the automated truck 110 to modify a sequence of navigation instructions based on a location identifier that updates or corrects a location of the truck 110 based on the target model. The navigation path control processor 516 can modify operation of the automated truck to correspond to a sequence of navigation instructions, including a sequence of navigation instructions modified by the navigation path indication processor 514.

The local orientation engine 520 can control orientation of the automated truck 110. For example, the local orientation engine 520 can control the automated truck 110 to change heading to correct a heading misaligned a direction of a roadway as indicated by a target model. The local orientation engine 520 can modify orientation of the automated truck 110 based on a plane corresponding to one or more location indicators, or a plurality of target model planes, as discussed herein. Thus, the local orientation engine 520 can provide a technical solution of providing real-time or live orientation calibration, correction, and control to an automated truck 110, to provide a technical improvement including orientation calibration, correction, and control independent of external communication networks. The local orientation engine 520 can include a heading processor 522, a steering feedback indication processor 524, and a steering feedback control processor 526.

The heading processor 522 can identify a heading corresponding to the automated truck 110, and can identify a target heading corresponding to an orientation indicator generated by the orientation engine 460. The heading processor 522 can generate a heading difference or heading delta between a heading corresponding to the automated truck 110 and a target heading corresponding to an orientation indicator generated by the orientation engine 460. The steering feedback indication processor 524 can generate a steering modification instruction corresponding to the heading difference or heading delta to modify a heading of the automated truck 110 to align with the target heading. The steering feedback control processor 526 can modify a steering modification instruction based on a live heading or rate of change of heading. For example, the steering feedback indication processor 524 can modify a heading to reduce or eliminate oversteer in a heading change.

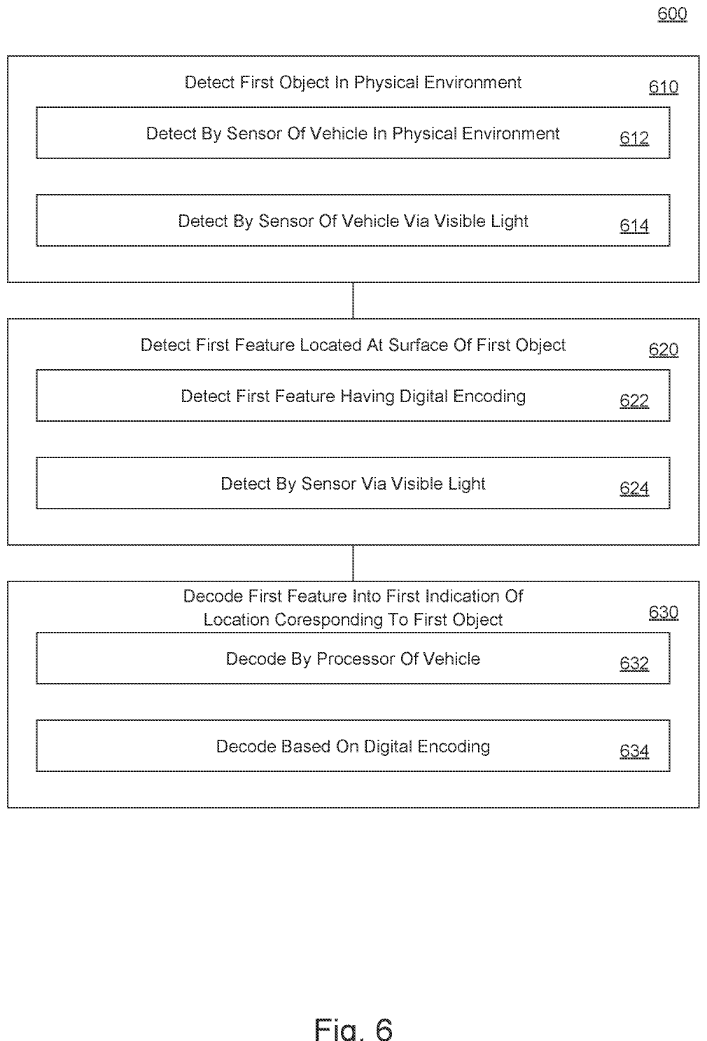

FIG. 6 depicts an example method of detection of encoded indicators in a physical environment, in accordance with present implementations. At least one of the autonomy system 300, the perception module 400, or the vehicle control module 500, or any component thereof, can perform method 600.

At 610, the method 600 can detect a first object in the physical environment. At 612, the method 600 can detect by a sensor of a vehicle in a physical environment. For example, the method can include detecting, by the sensor of the vehicle, a second object in the physical environment, the first object and the second object at least partially surrounding the vehicle in the physical environment. For example, a first object can correspond to a first target or a first visual code of a first target, and a second object can correspond to a second target or a first visual code of a first target. At 614, the method 600 can detect by a sensor of a vehicle via visible light.

At 620, the method 600 can detect a first feature located at a surface of the first object. At 622, the method 600 can detect a first feature having a digital encoding. For example, the method can include detecting, by the sensor via the visible light, a second feature having the digital encoding and located at a surface of the second object. The method can include decoding, by the processor of the vehicle and based on the digital encoding, the second feature into a second indication of location corresponding to the second object. For example, a first feature can correspond to a first visual code or a portion of a first visual code, and a second feature can correspond to a second visual code or a portion of a second visual code. For example, a portion of a visual code can correspond to a pad of a QR code to indicate orientation of the QR code. At 624, the method 600 can detect by the sensor via the visible light. At 630, the method 600 can decode the first feature into a first indication of location corresponding to the first object. At 632, the method 600 can decode by a processor of the vehicle. At 634, the method 600 can decode based on the digital encoding.

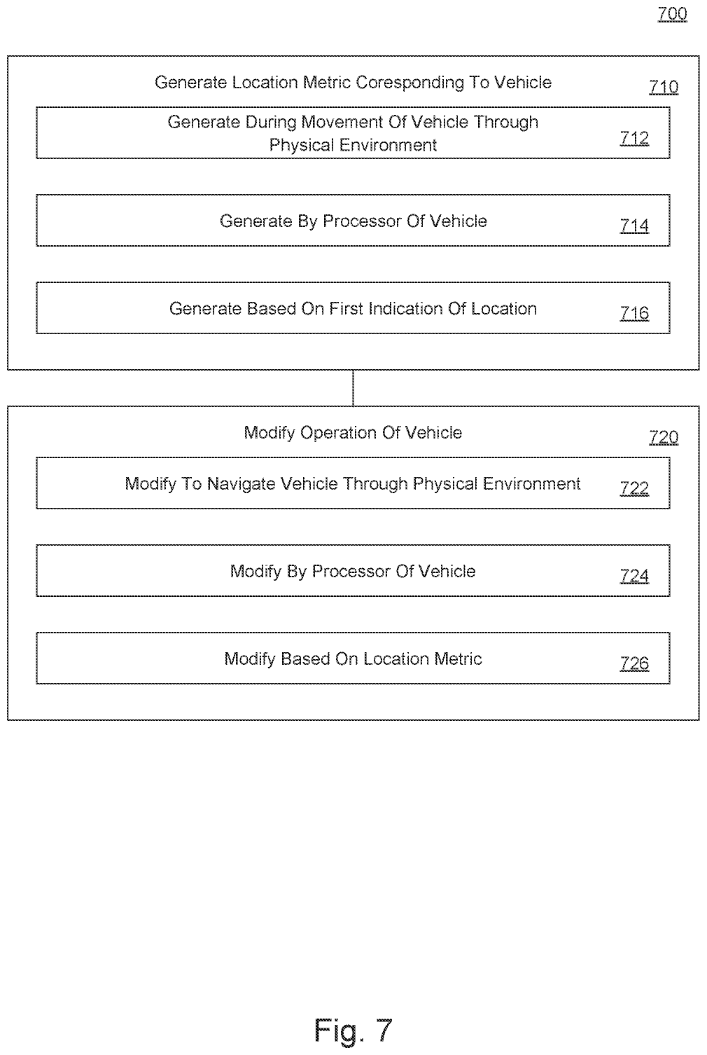

FIG. 7 depicts an example method of location determination via encoded indicators in a physical environment, in accordance with present implementations. At least one of the autonomy system 300, the perception module 400, or the vehicle control module 500, or any component thereof, can perform method 700.

At 710, the method 700 can generate a location metric corresponding to the vehicle. At 712, the method 700 can generate during movement of the vehicle through the physical environment. For example, the method can include generating, by the processor of the vehicle during movement of the vehicle through the physical environment, the location metric. For example, the method can include generating, by the processor of the vehicle and based on the first indication of location and the second indication of location, the location metric during movement of the vehicle through the physical environment while at least partially surrounded by the first object and the second object. At 714, the method 700 can generate a location metric corresponding to the vehicle by the processor of the vehicle.

At 716, the method 700 can generate a location metric corresponding to the vehicle based on the first indication of location. For example, the method can include generating, by the processor of the vehicle and based on the first indication of location and the second indication of location, an orientation metric corresponding to a geometric feature can include the first object and the second object in the physical environment. For example, a geometric feature as discussed herein can correspond to a shape present in or compatible with a visual code. For example, a geometric feature can include a square shape having a black or white color, and can include a collection of square or rectangular shapes having one or more black color squares or one or more white color squares. For example, the method can include generating, by the processor of the vehicle during movement of the vehicle through the physical environment, the orientation metric.

At 720, the method 700 can modify operation of the vehicle. For example, the method can include modifying, by the processor of the vehicle based on the orientation metric, operation of the vehicle to orient the vehicle in the physical environment according to the orientation metric. At 722, the method 700 can modify to navigate the vehicle through the physical environment. At 724, the method 700 can modify by the processor of the vehicle. At 726, the method 700 can modify based on the location metric.

For example, the vehicle can include the sensor to detect a second object in the physical environment, the first object and the second object at least partially surrounding the vehicle in the physical environment. For example, the vehicle can include the sensor to detect via the visible light, a second feature having the digital encoding and located at a surface of the second object. The can include the processor to decode, based on the digital encoding, the second feature into a second indication of location corresponding to the second object.

For example, the vehicle can include the processor to generate, based on the first indication of location and the second indication of location, the location metric during movement of the vehicle through the physical environment while at least partially surrounded by the first object and the second object. For example, the vehicle can include the processor to generate, based on the first indication of location and the second indication of location, an orientation metric corresponding to a geometric feature can include the first object and the second object in the physical environment. For example, the vehicle can include the processor to modify, based on the orientation metric, operation of the vehicle to orient the vehicle in the physical environment according to the orientation metric. For example, the vehicle can include the processor to generate, during movement of the vehicle through the physical environment, the orientation metric. For example, the vehicle can include the processor to generate, during movement of the vehicle through the physical environment, the location metric.

For example, the computer readable medium can include one or more instructions executable by a processor to decode, based on the digital encoding, a second feature into a second indication of location corresponding to the second object, the second feature having the digital encoding and located at a surface of a second object in the physical environment, the first object and the second object at least partially surrounding the vehicle in the physical environment. For example, the computer readable medium can include one or more instructions executable by the processor to generate, based on the first indication of location and the second indication of location, the location metric during movement of the vehicle through the physical environment while at least partially surrounded by the first object and the second object. For example, the computer readable medium can include one or more instructions executable by the processor to generate, based on the first indication of location and the second indication of location, an orientation metric corresponding to a geometric feature can include the first object and the second object in the physical environment.

Having now described some illustrative implementations, the foregoing is illustrative and not limiting, having been presented by way of example. In particular, although many of the examples presented herein involve specific combinations of method acts or system elements, those acts and those elements may be combined in other was to accomplish the same objectives. Acts, elements and features discussed in connection with one implementation are not intended to be excluded from a similar role in other implementations.

The phraseology and terminology used herein is for the purpose of description and should not be regarded as limiting. The use of “including.” “comprising.” “having.” “containing.” “involving.” “characterized by.” “characterized in that,” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B” can include only ‘A’, only ‘B’, as well as both “A’ and ‘B’. Such references used in conjunction with “comprising” or other open terminology can include additional items. References to “is” or “are” may be construed as nonlimiting to the implementation or action referenced in connection with that term. The terms “is” or “are” or any tense or derivative thereof, are interchangeable and synonymous with “can be” as used herein, unless stated otherwise herein.

Directional indicators depicted herein are example directions to facilitate understanding of the examples discussed herein, and are not limited to the directional indicators depicted herein. Any directional indicator depicted herein can be modified to the reverse direction, or can be modified to include both the depicted direction and a direction reverse to the depicted direction, unless stated otherwise herein. While operations are depicted in the drawings in a particular order, such operations are not required to be performed in the particular order shown or in sequential order, and all illustrated operations are not required to be performed. Actions described herein can be performed in a different order. Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Scope of the systems and methods described herein is thus indicated by the appended claims, rather than the foregoing description. The scope of the claims includes equivalents to the meaning and scope of the appended claims.

What is claimed is:

1. A method to spatially position a vehicle in transit through a physical environment, the method comprising:
detecting, by a sensor of a vehicle in a physical environment via visible light, a first object in the physical environment;
detecting, by the sensor via the visible light, a first feature a having a digital encoding and located at a surface of the first object;
decoding, by a processor of the vehicle and based on the digital encoding, the first feature into a first indication of location corresponding to the first object;
generating, by the processor of the vehicle during movement of the vehicle through the physical environment and based on the first indication of location, a location metric corresponding to the vehicle; and
modifying, by the processor of the vehicle based on the location metric, operation of the vehicle to navigate the vehicle through the physical environment according to the location metric.

2. The method of claim 1, further comprising:
detecting, by the sensor of the vehicle, a second object in the physical environment, the first object and the second object at least partially surrounding the vehicle in the physical environment.

3. The method of claim 2, further comprising:
detecting, by the sensor via the visible light, a second feature having the digital encoding and located at a surface of the second object; and
decoding, by the processor of the vehicle and based on the digital encoding, the second feature into a second indication of location corresponding to the second object.

4. The method of claim 3, further comprising:
generating, by the processor of the vehicle and based on the first indication of location and the second indication of location, the location metric during movement of the vehicle through the physical environment while at least partially surrounded by the first object and the second object.

5. The method of claim 3, further comprising:
generating, by the processor of the vehicle and based on the first indication of location and the second indication of location, an orientation metric corresponding to a geometric feature including the first object and the second object in the physical environment.

6. The method of claim 5, further comprising:
modifying, by the processor of the vehicle based on the orientation metric, operation of the vehicle to orient the vehicle in the physical environment according to the orientation metric.

7. The method of claim 6, further comprising.
generating, by the processor of the vehicle during movement of the vehicle through the physical environment, the orientation metric.

8. The method of claim 1, further comprising:
generating, by the processor of the vehicle during movement of the vehicle through the physical environment, the location metric.

9. A vehicle, comprising:
a sensor to detect, via visible light, a first object in a physical environment and a first feature a having a digital encoding and located at a surface of the first object; and
a non-transitory memory and a processor to spatially position a vehicle in transit through a physical environment, by:
decoding, based on the digital encoding, the first feature into a first indication of location corresponding to the first object;
generating, during movement of the vehicle through the physical environment and based on the first indication of location, a location metric corresponding to the vehicle; and
modifying, based on the location metric, operation of the vehicle to navigate the vehicle through the physical environment according to the location metric.

10. The vehicle of claim 9, further comprising:
the sensor to detect a second object in the physical environment, the first object and the second object at least partially surrounding the vehicle in the physical environment.

11. The vehicle of claim 10, further comprising:
the sensor to detect via the visible light, a second feature having the digital encoding and located at a surface of the second object; and
the processor to decode, based on the digital encoding, the second feature into a second indication of location corresponding to the second object.

12. The vehicle of claim 11, further comprising:
the processor to generate, based on the first indication of location and the second indication of location, the location metric during movement of the vehicle through the physical environment while at least partially surrounded by the first object and the second object.

13. The vehicle of claim 11, further comprising:
the processor to generate, based on the first indication of location and the second indication of location, an orientation metric corresponding to a geometric feature including the first object and the second object in the physical environment.

14. The vehicle of claim 13, further comprising:
the processor to modify, based on the orientation metric, operation of the vehicle to orient the vehicle in the physical environment according to the orientation metric.

15. The vehicle of claim 13, further comprising:
the processor to generate, during movement of the vehicle through the physical environment, the orientation metric.

16. The vehicle of claim 9, further comprising:
the processor to generate, during movement of the vehicle through the physical environment, the location metric.

17. A non-transitory computer readable medium including one or more instructions stored thereon and executable by a processor to:
decode, by the processor and based on a digital encoding of a first feature located at a surface of a first object in a physical environment, the first feature into a first indication of location corresponding to the first object;
generate, by the processor and during movement of the vehicle through the physical environment and based on the first indication of location, a location metric corresponding to the vehicle; and
modify, by the processor and based on the location metric, operation of the vehicle to navigate the vehicle through the physical environment according to the location metric.

18. The computer readable medium of claim 17, wherein the computer readable medium further includes one or more instructions executable by the processor to:
decode, by the processor and based on the digital encoding, a second feature into a second indication of location corresponding to the second object, the second feature having the digital encoding and located at a surface of a second object in the physical environment,
the first object and the second object at least partially surrounding the vehicle in the physical environment.

19. The computer readable medium of claim 17, wherein the computer readable medium further includes one or more instructions executable by the processor to:
generate, by the processor and based on the first indication of location and the second indication of location, the location metric during movement of the vehicle through the physical environment while at least partially surrounded by the first object and the second object.

20. The computer readable medium of claim 17, wherein the computer readable medium further includes one or more instructions executable by the processor to:
generate, by the processor and based on the first indication of location and the second indication of location, an orientation metric corresponding to a geometric feature including the first object and the second object in the physical environment.
